(19) United States
(12) Patent Application Publication
(10) Pub. No.: US 2011/0083151 A1
(43) Pub. Date: Apr. 7, 2011

(54) METHOD FOR RECORDING A MOVING PICTURE AND BROADCASTING RECEIVER ENABLING THE METHOD

(76) Inventor: Hyo Yeong Kim, Gyeongsangbuk-do (KR)

(21) Appl. No.: 12/673,629

(22) PCT Filed: Apr. 23, 2008
(86) PCT No.: PCT/KR08/02273

§ 371 Date: Dec. 20, 2010

(30) Foreign Application Priority Data
Aug. 17, 2007 (KR) 10-2007-0082755

(51) Int. Cl. H04N 5/445

(52) U.S. Cl. 725/53

(57) ABSTRACT

The present invention relates to a broadcast receiver, and more particularly, to a method for automatically extracting specific sections (201, 202, 203) of a moving picture which a user wishes to record and for editing the extracted sections (201, 202, 203) and a broadcast receiver adopting the same.

### TECHNICAL FIELD

The present invention relates to a broadcasting receiver (or broadcast receiver), and more particularly, to a method for automatically extracting specific sections of a moving picture which a user wishes to record and for editing the extracted sections and a broadcast receiver adopting the same.

### BACKGROUND ART

With the recent development in imaging technology, there has been a significant increase in the launching and usage of TV sets and set-top boxes adopting a private video recorder (PVR) system, which can record and store moving pictures wanted or desired (or designated) by a user.

However, the related art PVR system is disadvantageous in that, in order for the user to extract and record specific sections of a moving picture (e.g., sections where the user's favorite singer appears on a music program, sections where a travel site or gourmet menu, which the user finds interesting, are introduced during a life and style information program, etc.), the user should personally view the specific broadcast program and manually record the sections of the program he or she wishes to keep.

Accordingly, in order to resolve the disadvantages of the related art, the development of a method for recording a moving picture and a broadcasting receiver enabling of the method is becoming highly in demand.

### DISCLOSURE OF INVENTION

### Technical Problem

An object of the present invention devised to solve the problem lies on proposing a method for recording a moving picture and a broadcasting receiver enabling of the method by enabling the user to automatically search, extract, and edit specific sections of a broadcast program desired (or designated) by the user, so that the user may conveniently edit the recorded sections of the broadcast program.

### Technical Solution

The object of the present invention can be achieved by providing, in a broadcast receiver recording a moving picture, a method of operating the broadcast receiver including a step of receiving at least one keyword from a user, a step of searching for the keyword from supplemental information associated with the moving picture, when the keyword is detected from the supplemental information, a step of determining a point of detection, at which the keyword is detected from the supplemental information, and a step of storing sections of the moving picture each corresponding to a specific time period approximate to the point of detection in a storage means.

In another aspect of the present invention, provided herein is, in a broadcast receiver recording a moving picture, the broadcast receiver including a user input unit receiving at least one keyword from a user, a keyword detection unit searching for the keyword from supplemental information associated with the moving picture, when the keyword is detected from the supplemental information, a control unit determining a point of detection, at which the keyword is detected from the caption data, and a storage means storing sections of the moving picture each corresponding to a specific time period approximate to the point of detection.

### ADVANTAGEOUS EFFECTS

The present invention is advantageous in that the broadcast receiver can search (or detect) and store sections of the moving picture corresponding to the keyword desired by the user, without requiring the user to personally view the moving picture and to manually record specific sections of the corresponding moving picture, and can connect the stored sections so as to create a new moving picture, thereby creating a moving picture configured only of specific sections of the original moving picture desired by the user.

### BRIEF DESCRIPTION OF THE DRAWINGS

FIG. 1 illustrates a process of recording a moving picture according to an embodiment of the present invention.

FIG. 2 illustrates an example of creating a new moving picture by connecting sections of a broadcast program that are approximate to points of detection, at which the keyword is detected from the caption data, according to an embodiment of the present invention.

FIG. 3 illustrates an example of a broadcast receiver according to an embodiment of the present invention.

### DESCRIPTION OF REFERENCE NUMERALS FOR MAIN PARTS

301: user input
302: keyword detection unit
303: control unit
304: storage means

### BEST MODE FOR CARRYING OUT THE INVENTION

Hereinafter, the method for recording a moving picture and the broadcasting receiver enabling of the method according to the present invention will now be described in detail with reference to the accompanying drawings.

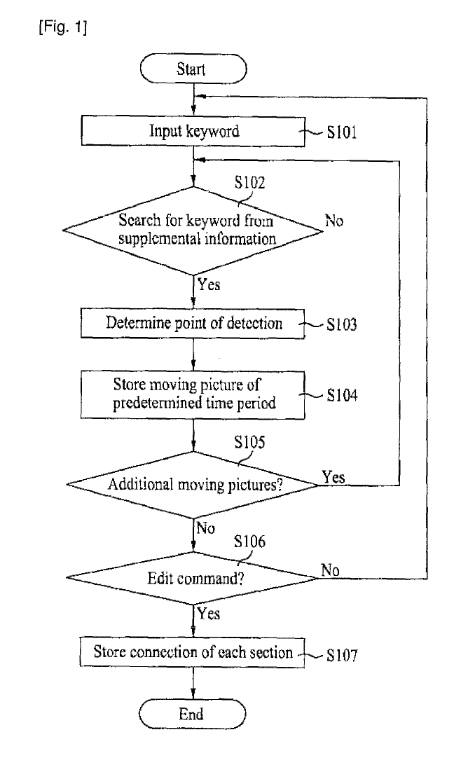

FIG. 1 illustrates a process of recording a moving picture according to an embodiment of the present invention.

In step S101, the broadcast receiver according to the present invention receives a keyword from the user. For example, the broadcast receiver may provide a user interface receiving keywords and may receive a keyword ‘Ivy’ from the user.

In step S102, the broadcast receiver searches for the keyword from a set of supplemental information associated with the moving picture.

At this point, the moving picture corresponds to a broadcast program received by a predetermined tuner, and the supplemental information may either be received by the tuner or be detected (or extracted) from a video signal of the broadcast program received by the tuner.

For example, the supplemental information may either correspond to caption data received by the tuner or correspond to subtitle data detected (or extracted) from the video signal of the broadcast program received by the tuner. The contents of the supplemental information may correspond to scripts included in the broadcast program or actual conversation held during the broadcast program.

For example, the moving picture may correspond to the broadcast program

‘Live on Music Camp’ which is received by the tuner, and the caption data may be associated with the corresponding broadcast program.

In the above example, the broadcast receiver detects (or extracts) the caption data associated with the broadcast program ‘Live on Music Camp’ and then the broadcast receiver searches for the keyword ‘Ivy’ from the caption data.

In step S103, when the keyword is searched (or detected) from the caption data, the broadcast receiver determines a point of search (or point of detection) at which the keyword is detected.

For example, when the running time of the entire section of the ‘Live on Music Camp’ corresponds to ‘58 minutes 06 seconds’ the point of detection at which the keyword ‘Ivy’ has been detected may correspond to ‘15 minutes 08 seconds’

In step S104, the broadcast receiver stores in the storage means the moving picture corresponding to a section of a specific time period most approximate to the point of detection.

The specific time period may either be predetermined in accordance with the embodiment of the present invention, or be received from the user.

Furthermore, the starting point of the time period section may correspond to the actual point of detection, or the starting point of the time period section may be set to be a predetermined amount of time before or after the actual point of detection.

For example, the broadcast receiver may store a moving picture corresponding to ‘5 minutes’ starting from the point of detection designated at ‘15 minutes 08 seconds’ in the storage means.

At this point, since the caption data may include a plurality of keywords, the broadcast receiver may search for a plurality of keywords, and the broadcast receiver may store each of the moving pictures corresponding to the section of predetermined time period most approximate to each respective point of detection in the storage means.

For example, since the keyword ‘Ivy’ may be included twice in the caption data of ‘Live on Music Camp’, a section corresponding to ‘5 minutes’ from each point of detection may be stored in the storage means.

Additionally, according to the embodiment of the present invention, a plurality of moving pictures from which the keyword is extracted may exist. At this point, the user may set up the system so that the user interface can search the keyword from the plurality of moving pictures.

In this case, the broadcast receiver determines whether additional moving pictures from which the keyword is to be searched exist in step S105. Then, when it is determined that additional moving pictures exist, the process steps S101 to S104, wherein the keyword is searched and the moving picture of a particular time section is stored, are repeatedly performed on the additional moving pictures.

When it is determined, based upon the result of step S105, that additional moving pictures from which the keyword is to be searched do not exist, the broadcast receiver determines whether an edit command is inputted by the user in step S106.

Based upon the result of step S106, when it is determined that an edit command has been inputted, the broadcast receiver connects the plurality of moving picture sections that is stored in the storage means so as to create at least one new moving picture, thereby storing the newly created moving picture in the storage means. At this point, when a total length of the connected sections for the moving picture is excessively long, a plurality of new moving pictures may be created.

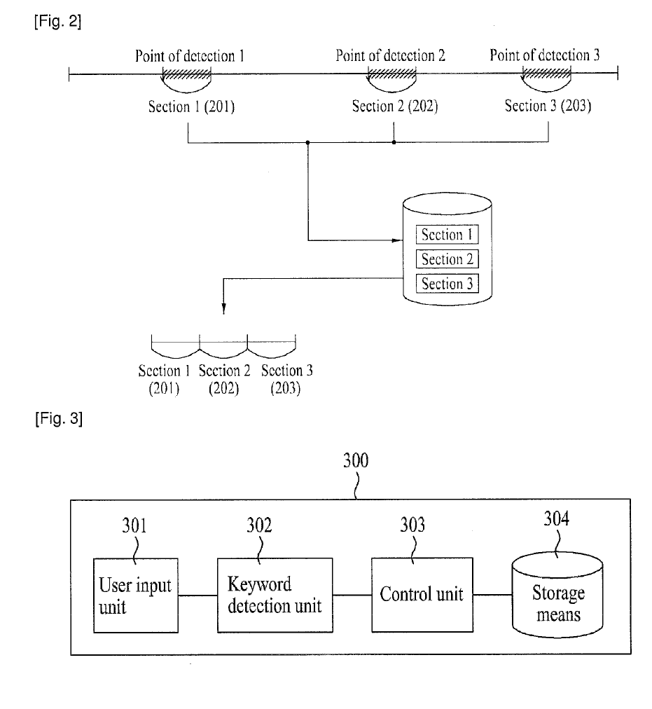

FIG. 2 illustrates an example of creating a new moving picture by connecting sections of a broadcast program that are approximate to points of detection, at which the keyword is detected from the caption data, according to an embodiment of the present invention.

Referring to FIG. 2, the broadcast receiver may connect Section 1 (201), Section 2 (202), and Section 3 (203), which are stored as results of the keyword search (or detection), so as to create a new moving picture.

Therefore, the present invention is advantageous in that the broadcast receiver can search (or detect) and store sections of the moving picture corresponding to the keyword desired by the user, without requiring the user to personally view the moving picture and to manually record specific sections of the corresponding moving picture, and can connect the stored sections so as to create a new moving picture, thereby creating a moving picture configured only of specific sections of the original moving picture desired by the user.

FIG. 3 illustrates an example of a broadcast receiver according to an embodiment of the present invention. Referring to FIG. 3, the broadcast receiver 300 according to the embodiment of the present invention includes a user input unit 301, a keyword detection unit 302, a control unit 303, and a storage means 304.

The user input unit 301 receives a keyword from the user.

The keyword detection unit 302 searches for the keyword in the supplemental information associated with the moving picture. The moving picture corresponds to a broadcast program received by a specific tuner, and the supplemental information may be either received by the tuner or detected from the broadcast program. Additionally, the supplemental information may either correspond to caption data received by the tuner or correspond to subtitle data detected from the video signal received by the tuner.

Furthermore, a plurality of moving pictures may exist, and the moving pictures may be designated by the user.

When the keyword is detected from the caption data, the control unit 303 determines a point of detection at which the keyword is searched and detected from the caption data.

The storage means 304 stores a section of the moving picture corresponding to a specific time period approximate to the point of detection. As described above, at this point, the user input unit may receive the specific time period from the user.

Then, the user input unit 301 receives an edit command from the user, and the control unit 303 may connect the plurality of moving picture sections stored in the storage means, so as to create at least one new moving picture.

The above-description corresponds to the broadcast receiver according to the present invention. And, since the technical details described in the embodiments presented herein may be applied to the broadcast receiver shown in FIG. 3 without any modification, a detailed description of the same will be omitted for simplicity.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### MODE FOR THE INVENTION

A plurality of embodiments has been described based upon the best mode for carrying out the present invention.

### INDUSTRIAL APPLICABILITY

The present invention provides a broadcast receiver broadcast receiver that can search (or detect) and store sections of the moving picture corresponding to the keyword desired by the user, without requiring the user to personally view the moving picture and to manually record specific sections of the corresponding moving picture, and that can connect the stored sections so as to create a new moving picture, thereby creating a moving picture configured only of specific sections of the original moving picture desired by the user.

1. In a broadcast receiver recording a moving picture, a method of operating the broadcast receiver, comprising:
a step of receiving at least one keyword from a user;
a step of searching for the keyword from supplemental information associated with the moving picture;
when the keyword is detected from the supplemental information, a step of determining a point of detection, at which the keyword is detected from the supplemental information; and
a step of storing sections of the moving picture each corresponding to a specific time period approximate to the point of detection in a storage means.

2. The method of claim 1, wherein the supplemental information corresponds to caption data.

3. The method of claim 2, wherein the moving picture corresponds to a broadcast program received by a tuner, and wherein the caption data are received by the tuner.

4. The method of claim 1, wherein the supplemental information is either received by a particular tuner, or wherein the supplemental information is detected from a video signal of a broadcast program received by the tuner.

5. The method of claim 1, wherein a plurality of moving pictures exist, and wherein each moving picture is designated by the user.

6. The method of claim 1, further comprising:
a step of receiving an edit command from the user; and
a step of connecting the plurality of sections stored in the storage means, so as to create at least one new moving picture.

7. The method of claim 1, further comprising:
a step of receiving the section corresponding to a specific time period from the user.

8. In a broadcast receiver recording a moving picture, the broadcast receiver, comprising:
a user input unit receiving at least one keyword from a user;
a keyword detection unit searching for the keyword from supplemental information associated with the moving picture;
when the keyword is detected from the supplemental information, a control unit determining a point of detection, at which the keyword is detected from the caption data; and
a storage means storing sections of the moving picture each corresponding to a specific time period approximate to the point of detection.

9. The broadcast receiver of claim 8, wherein the supplemental information corresponds to caption data.

10. The broadcast receiver of claim 8, wherein the moving picture corresponds to a broadcast program received by a tuner, and wherein the caption data are received by the tuner.

11. The broadcast receiver of claim 8, wherein the supplemental information is either received by a particular tuner, or wherein the supplemental information is detected from a video signal of a broadcast program received by the tuner.

12. The broadcast receiver of claim 8, wherein the user input unit receives an edit command from the user, and wherein the control unit connects the plurality of moving pictures stored in the storage means, so as to create at least one new moving picture.

13. The broadcast receiver of claim 8, wherein the user input unit receives the section corresponding to a specific time period from the user.

14. The broadcast receiver of claim 8, wherein a plurality of moving pictures exist, and wherein each moving picture is designated by the user.
